(19) United States
(12) Patent Application Publication
(10) Pub. No.: US 2001/0046823 A1
(43) Pub. Date: Nov. 29, 2001

(54) Fabric for air bag

(75) Inventors: Hidehito Sogi, Osaka (JP); Yoshihiro Arima, Osaka (JP)

Correspondence Address: Jordan and Hamburg LLP, 122 East 42nd Street, New York, NY, 10168, US

(73) Assignee: Toyo Tire & Rubber Co., Ltd.

(21) Appl. No.: 09/858,370

(22) Filed: May 16, 2001

Related U.S. Application Data
(63) Continuation-in-part of application No. 09/243,294, filed on Feb. 2, 1999.

(30) Foreign Application Priority Data
Dec. 8, 1998 (JP) 10-348927
Dec. 8, 1998 (JP) 10-348928

(51) Int. Cl. B32B 9/00; B60R 21/16; B32B 3/00; D03D 25/00; D03D 15/00; B32B 5/02

(52) U.S. Cl. 442/59; 280/743.1; 442/181

(57) ABSTRACT

An air bag made of a fabric having a excellent creasing property upon folding, wherein the fabric is a coated fabric prepared by coating a coating material comprising silicone rubber to a woven fabric made of synthetic fibers such as polyamide fibers, and the fabric has a bending hysteresis as measured according to KES-FB-2 of 0.55 gf·cm/cm or more as an average value of bendings in the direction of wefts and in the direction of warps of the woven fabric.

This is a continuation-in-part, of application Ser. No. 09/243,294, filed Feb. 2, 1999.

### BACKGROUND OF THE INVENTION

The present invention concerns a fabric for use in various kinds of air bags such as air bags for driver's seats and air bags for passenger's seats. More specifically, it relates to a fabric for use in air bags that tends to crease easily upon folding. Further, the present invention relates to an air bag made of such a fabric.

An air bag is generally contained in a folded state into a containing portion disposed in a central portion of a steering wheel or in an instrument panel of a vehicle and is deployed and expanded in a vehicle chamber by a gas generated from an inflator to hold an occupant upon collision of the vehicle.

As a fabric for air bags, a woven fabric made of synthetic fibers such as polyamide fibers is generally used. Gas impermeability is demanded for the air bag fabric since the air bag is expanded by the gas generated from the inflator to hold the occupant as described above. Further, it is also necessary to prevent fraying of fabric threads from a cut end which is formed by cutting during manufacture of the air bag. Therefore, a coated fabric prepared by coating a

However, since the coated fabric is less easily creased due to the elasticity of the rubber of the coating layer, the operational efficiency of folding and encasing the air bag worsens.

In view of the above, it is an object of the present invention to provide an air bag fabric made of a coated fabric that is more easily creased.

### SUMMARY OF THE INVENTION

A fabric for air bags according to the first embodiment of the present invention is a coated fabric prepared by coating a coating material on a substrate fabric made of synthetic fibers. The coated fabric has a bending hysteresis as measured according to KES-FB-2 of 0.55 gf·cm/cm or more as an average value of bendings in two directions perpendicular to each other within a plane of the coated fabric.

The average value for the bendings in the two directions perpendicular to each other can be defined, for example, as an average value of bending in the direction of weft and bending in the direction of warp where the substrate fabric is a woven fabric comprising weft and warp.

Since the fabric for air bags has a bending hysteresis of 0.55 gf·cm/cm or more, it tends to crease easily upon folding and, accordingly, it provides an excellent operational efficiency during folding and encasing of the air bag. Further, since the fabric is coated fabric, it has excellent gas impermeability and it can prevent fraying of threads caused by cutting.

For the coating material described above, a coating material comprising silicone rubber is used preferably. When a coating material comprising silicone rubber is used, environmental resistance such as heat resistance and weather resistance is superior to that obtained when using a coating material comprising chloroprene rubber.

Further, the coating material is preferably coated on only one surface of the substrate fabric. This is because the fabric for use in air bags is stiffened and the flexibility of the fabric deteriorates if the coating is applied on both surfaces of the substrate fabric or if the substrate fabric is immersed in the coating material.

Additionally, the amount of coating material applied is preferably 20 g/m² or less based on the solids content. When the coating material is coated in such a small weight per unit area, the thickness of the substrate fabric after coating is substantially identical to the thickness of the substrate fabric before coating, so that a soft and inexpensive air bag fabric can be obtained and the packaging volume of the air bag can be reduced.

A fabric for air bags according to the second embodiment of the present invention is a coated fabric prepared by coating a coating material comprising silicone rubber on one surface of a substrate fabric made of synthetic fibers. The coating is applied in an amount of 20 g/m² or less based on a solids content, and the thickness of the fabric is not more than 1.04 times, that is, from 1.00 to 1.04 times the thickness of the substrate fabric.

In the fabric for air bags, since the weight per unit of area of the coating is small, and an extremely thin coating layer is formed such that the thickness after coating is substantially identical to the thickness of the substrate fabric before coating. The coated fabric tends to crease more easily, and is softer and less expensive than existing coated fabrics having a thick coating layer. Therefore, the air bag provides an excellent operational efficiency during folding and encasing of the air bag and the packaging volume can be reduced. Furthermore, since the fabric is a coated fabric, it has excellent gas impermeability and can prevent fraying of threads caused by cutting. Further, since the coating material comprises silicone rubber, it provides superior environmental resistance such as heat resistance and weather resistance as compared to a coating material comprising chloroprene rubber.

In the fabric for air bags according to the present invention, the substrate fabric preferably comprises a woven fabric having a cover factor of from 1700 to 2100. When a woven fabric of a relatively low density is used as a base and is coated with a coating material at a small weight per unit of area, the coating material intrudes into the tissue of the woven fabric surface layer to improve the film strength, making the coating layer less breakable upon expansion and deployment of the air bag and improving its flexibility.

### BRIEF EXPLANATION OF THE DRAWING

FIG. 1 is an enlarged cross sectional view of a fabric for use in air bags according to an embodiment of the present invention.

### DETAILED DESCRIPTION OF A PREFERRED EMBODIMENT

A fabric for use in air bags according to the present invention is a coated fabric having a bending hysteresis as measured according to KES-FB-2 of 0.55 gf·cm/cm or more. There is no particular restriction on the materials for producing a coated fabric having such a large bending hysteresis but it can be obtained, as described later, by using a substrate fabric having a relatively low density and coating a coating material comprising silicone rubber at a small weight per unit of area on one surface of the substrate fabric.

KES-FB-2 mentioned herein is related to bending characteristics according to KES (Kawabata Evaluation System) which is a system for measuring the basic dynamic property and surface property of a fabric in a low load region. The measurement is according to the following procedures. A specimen (specimen length: for example, 10 cm) is held in two chucks at 1 cm distance. One chuck is moved to conduct pure bending at an equi-velocity curvature within the range of curvature K=−2.5˜2.5 cm−1, and the bending moment M (gf·cm/cm) of the specimen per unit length is measured to determine an average value for hysteresis width 2HB of the bending moment M in a range of curvature K=0.5˜1.5 and −0.5˜−1.5. This is measured for both bendings of the specimen in two directions perpendicular to each other. For example, in both the bending in the direction of weft and bending in the direction of warp of the woven fabric, an average value of the two measurements is calculated.

The substrate fabric coated with the coating material can include woven fabrics of polyamide fibers such as polyamide 6, polyamide 66, polyester fibers such as polyethylene terephthalate and aramid fibers. Plain weave fabric of polyamide fibers is particularly preferred.

As the substrate fabric, a woven fabric having a cover factor from 1700 to 2100 is preferably used. It is difficult to ensure a sufficient strength of the air bag if the cover factor is less than 1700. If the cover factor exceeds 2100, the substrate fabric increases its rigidity and exhibits poor flexibility.

The cover factor is defined herein according to the following equation (1). In the equation, “warp density” is a number of counts of warp per 1 inch, and “weft density” is a number of counts of weft per 1 inch.

Warp density×√(denier of warp)+weft density×√(denier of weft)=cover factor (1)

The denier of synthetic fibers constituting the woven fabric can be 120 to 630 denier, in which the counts of weft and warp are determined depending on the denier so as to satisfy the numerical range of the cover factor described above.

More specifically, a substrate fabric comprising a plain weave fabric made of polyamide 66 having a fineness of 420 denier and having counts of from 42 to 48 per inch each for weft and warp is preferred. A substrate fabric comprising a plain weave fabric made of polyamide 66 having a fineness of 315 denier and having counts of from 51 to 56 per inch each for weft and warp is also preferred. A substrate fabric comprising a plain weave fabric made of polyamide 66 having a fineness of 210 denier and having counts of from 65 to 72 per inch each for weft and warp is also preferred. Further, a substrate fabric comprising a plain weave fabric made of polyamide 66 having a fineness of 120 denier and having counts of from 84 to 94 per inch each for weft and warp is also preferred.

As the coating material, a coating material comprising silicone rubber is suitable in view of its environmental resistance, for example, its heat resistance.

An addition reaction vulcanized type silicone rubber coating material comprising an alkenyl group-containing organopolysiloxane such as a dimethylpolysiloxane blocked at both terminal ends with dimethylvinylsiloxy groups as a main agent and blended with a fine powder silica as a reinforcing filler and, further, a curing agent such as organo hydrogen polysiloxane or a platinum group compound is suitable. The coating material may be optionally incorporated with an adhesion improver such as an epoxy group-containing organosilicone compound and a flame retardant aid such as carbon black. Furthermore, an organic solvent such as toluene may be added so that the coating can be applied easily in a thin film. In this case, the organic solvent is suitably added such that the viscosity of the coating material at 25° C. is from 10,000 to 50,000 cs.

The coating material is preferably coated on one surface of the substrate fabric in an amount of 20 g/m² or less based on the solids content. More preferably, the coating amount is from 5 to 20 g/m² based on the solids content.

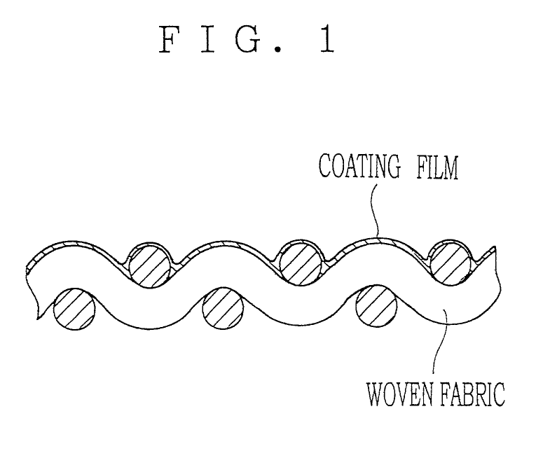

Since the woven fabric of a relatively low density is coated at such a small weight per unit of area as described above, a coating film is formed conforming to the unevenness of the woven fabric to such an extent that the feeling of unevenness of the woven fabric remains on the coated surface, as shown in FIG. 1. Also, the thickness after coating is substantially identical with the thickness of the woven fabric before coating. More specifically, the thickness of the coated fabric is from 1.00 to 1.04 times the thickness of the woven fabric. Thus, soft and inexpensive fabric for use in the air bags can be obtained. Further, the resulting coated fabric has a large bending hysteresis and, accordingly, tends to be creased easily upon folding so that folding and encasing of the air bag are facilitated. Furthermore, the packaging volume is also reduced.

The coating method of the coating material can be conducted by using various known coating machines such as a knife coater or comma coater. The coating material is cured through vulcanization by applying a heat treatment at an appropriate temperature condition after coating. To manufacture the air bag the resulting coated fabric is cut into a predetermined shape and then stitched with the coated surface being on the inner surface of the air bag.

The fabric for use in air bags according to the present invention preferably has an adhesion strength of 1 kgf/cm or more as measured according to JIS K6328.5.3.7 and a rigidity of less than 80 mm as measured according to JIS L1096.6.19.1A both in the direction of the weft and in the direction of the warp. Such an adhesion strength and rigidity can be attained by coating the woven fabric made of polyamide at a relatively low density with the coating material comprising silicone rubber at a small weight per unit of area.

The present invention is explained more specifically in the examples and comparative examples below, but the present invention is not restricted to the following examples.

### EXAMPLE 1

As shown in Table 1, a plain weave fabric comprising polyamide 66 of 420 denier and having a number of counts of 46 per inch each for weft and warp (cover factor=1885, thickness=0.280 mm) was used, and a coating material comprising silicone rubber was coated on one surface of the woven fabric in an amount of 15 g/m² based on a solids content. The coating material used was an addition reaction vulcanized type silicone rubber coating material comprising 23 parts by weight of a dimethylvinyl siloxy-terminated dimethyl polysiloxane, 7 parts by weight of fumed silica, one part by weight of an organohydrogen polysiloxane, 0.5 parts by weight of a platinum type compound, 1 part by weight of an epoxy group-containing organo silicone compound, 0.5 parts by weight of carbon black and 70 parts by weight of toluene. After coating, the fabric was subjected to a drying treatment in a drier at 180° C. for 7 minutes to obtain a fabric for air bags.

TABLE 1

| | | Example 1 | Example 2 | Example 3 |
|---|---|---|---|---|
| Coating material | | Silicone | Silicone | Silicone |
| | | rubber 15 g/m² | rubber 8 g/m² | rubber 19 g/m² |
| Woven | Material | Polyamide 66 | Polyamide 66 | Polyamide 66 |
| fabric | Fineness | 420d | 420d | 420d |
| | Count | 46/inch | 46/inch | 46/inch |
| | Cover | 1885 | 1885 | 1885 |
| | factor | | | |
| Thickness | Substrate | 0.280 | 0.280 | 0.280 |
| (mm) | fabric (a) | | | |
| | Coated | 0.281 | 0.280 | 0.288 |
| | fabric (b) | | | |
| Ratio of thickness | | 1.00 | 1.00 | 1.03 |
| (b)/(a) | | | | |
| Rigidity | Longitu- | 67 | 67 | 68 |
| (mm) | dinal | | | |
| | Lateral | 75 | 74 | 76 |
| Adhesion strength | | >2 | >2 | >2 |
| (kgf/cm) | | | | |
| Bending | Longitu- | 0.30 | 0.33 | 0.31 |
| hysteresis | dinal | | | |
| (gf · cm/ | Lateral | 0.85 | 0.94 | 0.78 |
| cm) | Average | 0.58 | 0.64 | 0.55 |

| | | | |
|---|---|---|---|
| Creasing property | ◯ | ◯ | ◯ |
| Packaging volume | 87 | 83 | 89 |

TABLE 2

| | | Comparative | Comparative | Comparative | Comparative |
|---|---|---|---|---|---|
| | | Example 1 | Example 2 | Example 3 | Example 4 |
| Coating material | | Silicone | Silicone | Silicone | Non-coated |
| | | rubber 40 g/m² | rubber 25 g/m² | rubber 21 g/m² | |
| Woven | Material | Polyamide 66 | Polyamide 66 | Polyamide 66 | Polyamide 66 |
| fabric | Fineness | 420d | 420d | 420d | 420d |
| | Count | 46/inch | 46/inch | 46/inch | 54/inch |
| | Cover | 1885 | 1885 | 1885 | 2213 |
| | factor | | | | |
| Thickness | Substrate | 0.280 | 0.280 | 0.280 | 0.322 |
| (mm) | fabric (a) | | | | |
| | Coated | 0.302 | 0.294 | 0.291 | — |
| | fabric (b) | | | | |
| Ratio of thickness | | 1.08 | 1.05 | 1.04 | — |
| (b)/(a) | | | | | |
| Rigidity | Longitu- | 68 | 68 | 68 | 72 |
| (mm) | dinal | | | | |
| | Lateral | 83 | 80 | 77 | 102 |
| Adhesion strength | | >2 | >2 | >2 | — |
| (kgf/cm) | | | | | |
| Bending | Longitu- | 0.23 | 0.26 | 0.28 | 0.45 |
| hysteresis | dinal | | | | |
| (gf · cm/cm) | Lateral | 0.58 | 0.70 | 0.77 | 1.52 |
| | Average | 0.41 | 0.48 | 0.53 | 0.99 |

| | | | | |
|---|---|---|---|---|
| Creasing property | X | X | X | ◯ |
| Packaging volume | 100 | 93 | 92 | 108 |

For the fabric for air bags of the above examples, thickness, rigidity, adhesion strength, bending hysteresis, creasing property upon folding and packaging volume were measured. Each of the measuring methods is as shown below.

Rigidity: JIS L 1096.6.19.1A method

Adhesion strength: JIS K 6328.5.3.7

Bending hysteresis: Both bending in the direction of weft and bending in the direction of warp were measured according to KES-FB-2 and an average value was determined. The length of the specimen was 10 cm.

Creasing property: the fabric for air bags was cut into two circular fabrics each of 760 mm diameter, and they were stitched to each other along circumferential edges to prepare an air bag for use in a driver's seat. The air bag was folded into a predetermined shape, placed in a vessel of length and width of 120 mm and 150 mm, respectively, and applied with an initial load of 3 kg for one hour and the state of relaxation upon releasing the load was confirmed visually. In the tables, O shows that the degree of relaxation is small and the creasing property is good, whereas X shows that the degree of relaxation is large and the creasing property is poor.

Packaging volume: the air bag for use in the driver's seat was folded with left-to-right bellows and vertical bellows, and the volume of the folded air bag was measured. In Tables 1-3, it is shown as an index relative to the folded volume of the air bag defined as 100 in Comparative Example 1.

### EXAMPLES 2, 3

Fabrics for the air bags of Example 2 and Example 3 were obtained by using woven fabric and coating material identical to that of Example 1, and the woven fabric was coated with the coating material at 8 g/m² for Example 2 and at 19 g/m² for Example 3, respectively.

### COMPARATIVE EXAMPLES 1 to 4

Fabrics for air bags of Comparative Examples 1 to 3 were obtained by using the woven fabric and the coating material identical to that of Example 1, and the woven fabric was coated with the coating material at 40 g/m² for Comparative Example 1, at 25 g/m² for Comparative Example 2 and at 21 g/m² for Comparative Example 3, respectively.

In Comparative Example 4, a fabric for air bags was prepared without applying the coating material to a plain weave fabric comprising polyamide 66 of 420 denier and having a number of counts of 54 per inch for each of the weft and warp (cover factor=2213, thickness=0.322 mm).

As shown in Table 1, the fabrics for the air bags of Examples 1 to 3 had a thickness substantially identical to the thickness of the substrate fabric before coating, namely, the thickness ratio (b)/(a), that is, the thickness of the coated fabric (b) relative to the thickness of the substrate fabric before coating (a) was 1.00, 1.00 and 1.03 respectively. The fabric had an extremely thin coating layer. Further, the bending hysteresis was as large as 0.55 gf·cm/cm or more. Therefore, it was easily creased and the prepared air bag can be folded easily upon folding. Further, since the thickness was reduced, the packaging volume of the air bag was small. Further, the rigidity was less than 80 mm both for the weft and warp and they exhibited excellent flexibility. Further, they also had excellent adhesion strength. Furthermore, since they were coated fabrics, they had excellent gas impermeability with the permeability being 0, and no thread fraying was caused due to cutting upon manufacture of the air bag.

On the contrary, since the fabrics for air bags of Comparative Examples 1 and 2 had thickness ratios (b)/(a) of 1.08 and 1.05 respectively, and the thickness was increased by coating, the bending hysteresis was as small as 0.41 and 0.48 respectively. Therefore, they tended to be creased to a lesser extent and the prepared air bags were not easily folded. Further, the packaging volume of the air bags was larger than that of Example 1.

The fabric for air bags in Comparative Example 3 had a relatively small thickness ratio (b)/(a) of 1.04 but the weight per unit area of the coating material was more than 20 g/m², so that the bending hysteresis was as small as 0.53 gf·cm/cm, and the creasing property upon folding was not sufficient. Further, the packaging volume of the air bag was larger than that of Example 1.

The fabric for the air bags of Comparative Example 4 had a bending hysteresis as large as 0.99 and tended to be creased easily. However, since the fiber density was increased in order to lower the gas permeability, the thickness was large and, accordingly, the packaging volume of the air bag was larger compared with each of the examples and it also exhibited poor flexibility. Furthermore, since the fabric for air bags of Comparative Example 4 was not coated, it had poor gas impermeability and fraying of threads was likely to be caused by cutting.

### EXAMPLE 4

As shown in Table 3, a plain weave fabric comprising polyamide 66 of 315 denier and having a number of counts of 53 per inch each for weft and warp (cover factor=1881, thickness=0.240 mm) was used, and a coating material identical to that in Example 1 was coated on one surface of the woven fabric in an amount of 14 g/m² based on a solids content. After coating, the fabric was subjected to a drying treatment in a drier at 180° C. for 7 minutes to obtain a fabric for air bags of Example 4.

### EXAMPLE 5

As shown in Table 3, a plain weave fabric comprising polyamide 66 of 210 denier and having a number of counts of 70 per inch each for weft and warp (cover factor=2029, thickness=0.201 mm) was used, and a coating material identical to that in Example 1 was coated on one surface of the woven fabric in an amount of 14 g/m² based on solids content. After coating, the fabric was subjected to a drying treatment in a drier at 180° C. for 7 minutes to obtain a fabric for air bags of Example 5.

### EXAMPLE 6

As shown in Table 3, a plain weave fabric comprising polyamide 66 of 120 denier and having a number of counts of 89 per inch each for weft and warp (cover factor=1950, thickness=0. 189 mm) was used, and a coating material identical to that in Example 1 was coated on one surface of the woven fabric in an amount of 12 g/m² based on solids content. After coating, the fabric was subjected to a drying treatment in a drier at 180° C. for 7 minutes to obtain a fabric for air bags of Example 6.

TABLE 3

| | | Example 4 | Example 5 | Example 6 |
|---|---|---|---|---|
| Coating material | | Silicone | Silicone | Silicone |
| | | rubber 14 g/m² | rubber 14 g/m² | rubber 12 g/m² |
| Woven | Material | Polyamide 66 | Polyamide 66 | Polyamide 66 |
| fabric | Fineness | 315d | 210d | 120d |
| | Count | 53/inch | 70/inch | 89/inch |
| | Cover | 1881 | 2029 | 1950 |
| | factor | | | |
| Thickness | Substrate | 0.240 | 0.201 | 0.189 |
| (mm) | fabric (a) | | | |
| | Coated | 0.241 | 0.202 | 0.190 |
| | fabric (b) | | | |
| Ratio of thickness | | 1.00 | 1.00 | 1.00 |
| (b)/(a) | | | | |
| Rigidity | Longitu- | 61 | 51 | 74 |
| (mm) | dinal | | | |
| | Lateral | 68 | 72 | 72 |
| Adhesion strength | | >2 | >2 | >2 |
| (kgf/cm) | | | | |
| Bending | Longitu- | 0.42 | 0.34 | 0.31 |
| hysteresis | dinal | | | |
| (gf · cm/ | Lateral | 1.10 | 0.96 | 0.83 |
| cm) | Average | 0.76 | 0.65 | 0.57 |

| | | | |
|---|---|---|---|
| Creasing property | ◯ | ◯ | ◯ |
| Packaging volume | 78 | 71 | 65 |

As shown in Table 3, the fabrics for air bags of Examples 4 to 6 were easily creased and the prepared air bag can be folded easily. Further, the packaging volume of the air bag was small. Furthermore, since they were coated fabrics, they exhibited excellent gas impermeability with the permeability being 0, and no thread fraying was caused due to cutting upon manufacture of the air bag.

What is claimed is:

1. An air bag made of a coated fabric which is prepared by coating a coating material comprising silicone rubber to a substrate fabric made of synthetic fibers by 20 g/m² or less based on a solid content and has a bending hysteresis as measured according to KES-FB-2 of 0.55 gf•cm/cm or more as an average value of bendings in two directions perpendicular to each other within a plane of the coated fabric.

2. An air bag made of a coated fabric which is prepared by coating a coating material comprising silicone rubber to a substrate woven fabric made of synthetic fibers by 20 g/m² or less based on a solid content and has a bending hysteresis as measured according to KES-FB-2 of 0.55 gf•cm/cm or more as an average value of bendings in the direction of wefts and in the direction of warps of the woven fabric.

3. An air bag as defined in claim 1 or 2, wherein the coating material is coated only one surface of the substrate fabric.

4. An air bag made of a coated fabric which is prepared by coating a coating material comprising silicone rubber on one surface of a substrate fabric made of synthetic fibers by 20 g/m² or less based on a solid content, wherein a thickness of the coated fabric is not more than 1.04 times a thickness of the substrate fabric.

5. An air bag as defined in claim 1 or 4, wherein the substrate fabric is a woven fabric having a cover factor of from 1700 to 2100.

6. An air bag as defined in claim 1 or 4, wherein the substrate fabric comprises a woven fabric made of polyamide 66 with a fineness of 420 denier and having a number of counts of from 42 to 48 per inch each for wefts and warps.

7. An air bag as defined in claim 1 or 4, wherein the substrate fabric comprises a woven fabric made of polyamide 66 with a fineness of 315 denier and having a number of counts of from 51 to 56 per inch each for wefts' and warps.

8. An air bag as defined in claim 1 or 4, wherein the substrate fabric comprises a woven fabric made of polyamide 66 with a fineness of 210 denier and having a number of counts of from 65 to 72 per inch each for wefts and warps.

9. An air bag as defined in claim 1 or 4, wherein the substrate fabric comprises a woven fabric made of polyamide 66 with a fineness of 120 denier and having a number of counts of from 84 to 94 per inch each for wefts and warps.
